(19) United States
(12) Patent Application Publication
(10) Pub. No.: US 2009/0317640 A1
(43) Pub. Date: Dec. 24, 2009

(54) METHOD OF FORMING A GAS BARRIER LAYER, A GAS BARRIER LAYER FORMED BY THE METHOD, AND A GAS BARRIER FILM

(75) Inventors: Toshiya TAKAHASHI, Odawara-shi (JP); Tatsuya Fujinami, Odawara-shi (JP); Shigehide Ito, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/484,723

(22) Filed: Jun. 15, 2009

(30) Foreign Application Priority Data
Jun. 20, 2008 (JP) 2008-161891

(51) Int. Cl. B32B 9/00; H05H 1/24

(52) U.S. Cl. 428/446; 427/569

(57) ABSTRACT

A method of forming a gas barrier layer comprises: forming a first layer over a substrate by plasma-enhanced CVD with a first plasma excitation power, at least a part of a surface of the substrate being made of an organic material; and forming a second layer on the first layer by plasma-enhanced CVD with a second plasma excitation power which is higher than the first plasma excitation power.

### BACKGROUND OF THE INVENTION

The present invention relates to the technical field of a gas barrier layer to be formed by plasma-enhanced CVD, more particularly to a method by which a gas barrier layer having high gas barrier quality can be formed using a substrate a surface of which is made of organic materials such as high-molecular weight compounds.

A gas barrier film (a water-vapor barrier film) having a gas barrier layer as a component is utilized not only at those sites or parts of optical devices, display apparatuses (e.g. liquid-crystal displays and organic EL displays) as well as various other devices including semiconductor devices and thin-film solar batteries which are required to be moisture-proof, but also in packaging materials used to pack foods, clothing items, electronic components, etc.

The gas barrier layer is a layer that is made of materials such as silicon oxide and silicon nitride that exhibit gas barrier quality and it is formed by a vapor-phase deposition process (vacuum deposition process) such as sputtering or CVD on a surface of the site that is required to be moisture-proof. Also used advantageously is a gas barrier film which is such that the above-mentioned gas barrier layer made of silicon nitride or the like is formed on a surface of films made of high-molecular weight materials (plastic films) or metal films.

An exemplary method of forming a gas barrier layer is plasma-enhanced CVD. JP 11-70611 A discloses a gas barrier film comprising a substrate that is made of a transparent organic material and which has formed on one or both of its surfaces a gas barrier layer which is a silicon oxide layer having 5-15% carbon, characterized in that the gas barrier layer is formed by plasma-enhanced CVD using an organosilicon compound gas and an oxygen gas as reaction gases.

As mentioned above, the gas barrier layer is a layer that is made of materials such as silicon nitride and silicon oxide that exhibit gas barrier quality and it is formed on a surface of a substrate such as a plastic film by a vapor-phase deposition process such as sputtering or CVD.

Needless to say, the gas barrier layer is formed in a sufficient thickness to meet the gas barrier performance required by a specific use of the final product (gas barrier film).

However, if the idea disclosed in JP 11-70611 A is applied to form a gas barrier layer by plasma-enhanced CVD on a substrate such as a plastic film that has a surface made of an organic material, it often occurs that the gas barrier layer, although it has the intended thickness, fails to have the intended gas barrier performance for its specific thickness.

### SUMMARY OF THE INVENTION

An object, therefore, of the present invention is to solve the above-mentioned problem of the prior art by providing a method by which a gas barrier layer that exhibits the intended gas barrier performance for their specific thickness can be formed consistently.

Another object of the present invention is to provide a gas barrier layer formed by the method.

Yet another object of the present invention is to provide a gas barrier film having such a gas barrier layer.

A method of forming a gas barrier layer according to the present invention comprises: forming a first layer over a substrate by plasma-enhanced CVD with a first plasma excitation power, at least a part of a surface of the substrate being made of an organic material; and forming a second layer on the first layer by plasma-enhanced CVD with a second plasma excitation power which is higher than the first plasma excitation power.

A gas barrier layer according to the present invention is one formed by the gas barrier layer forming method.

Further, a gas barrier film according to the present invention comprises: a substrate at least a part of a surface of which is made of an organic material; and the gas barrier layer which is formed over the substrate.

### BRIEF DESCRIPTION OF THE DRAWINGS

FIG. 1 is a sectional view showing a gas barrier film having a gas barrier layer formed in an enabling mode of the present invention.

### DETAILED DESCRIPTION OF THE INVENTION

On the following pages, the method of the present invention for forming gas barrier layers is described in detail, together with the gas barrier layer formed by this method.

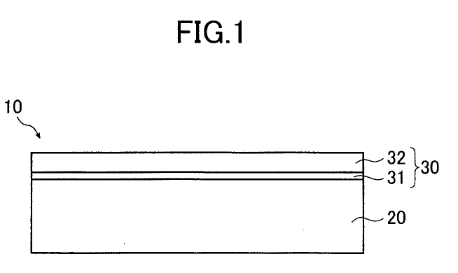

As shown in FIG. 1, the method of the present invention comprises forming a gas barrier film 10 by overlaying a substrate 20 having a surface made of an organic material with a gas barrier layer 30 through plasma-enhanced CVD.

To form the gas barrier layer 30 on the surface of the substrate 20, a first plasma excitation power (hereinafter referred to as a first power) is first applied to form a first layer 31 in a specified thickness, then the first power is changed to a second plasma excitation power (hereinafter referred to as a second power) higher than the first power and the second power is applied to form the second layer 32 until the total thickness of the first layer 31 and the second layer 32 reaches an intended thickness.

The substrate 20 may be of various types as long as at least a part of a surface thereof is formed of organic materials such as high-molecular weight materials (polymers) or resin materials and if they permit the formation of the gas barrier layer by plasma-enhanced CVD; specifically, advantageous examples include substrates made of high-molecular weight materials such as polyethylene terephthalate (PET), polyethylene naphthalate, polyethylene, polypropylene, polystyrene, polyamides, polyvinyl chloride, polycarbonates, polyacrylonitrile, polyimides, polyacrylate, and polymethacrylate.

The substrate 20 is advantageously in film form (sheet form) but this is not the sole case and various kinds of articles (components) whose surface is made of organic materials can also be employed, as exemplified by optical devices such as lenses and optical filters, photoelectric transducers such as organic ELs and solar batteries, and display panels such as liquid-crystal displays and electronic papers.

Further in addition, the substrate 20 may be such that it comprises, as the main body, one of those articles that are made of plastic films or organic materials, metal films or glass sheets, or various metal articles and the like and which has formed on one of its surfaces (the side where the gas barrier layer is to be formed) those layers that are made of organic materials to provide various functions (e.g., a protective layer, an adhesive layer, a light reflecting layer, a light shield layer, a planarizing layer, a buffer layer, and a stress relaxing layer).

The gas barrier layer 30 is formed on that surface of the substrate 20 by plasma-enhanced CVD, and all known types of plasma-enhanced CVD techniques can be employed, as exemplified by CCP (capacitively coupled plasma)-enhanced CVD and ICP (inductively coupled plasma)-enhanced CVD.

When the prior art described above was used to form a gas barrier layer by plasma-enhanced CVD on the substrate such as a plastic film that had a surface made of organic materials, the resulting gas barrier layer had the intended thickness (a sufficient thickness to provide the required gas barrier quality) and yet it did not have the intended gas barrier quality; as a result, it often occurred that the gas barrier film as the final product also failed to have the desired gas barrier quality.

The present inventors made an intensive study with a view to identifying the cause of that phenomenon and found that when a gas barrier layer was formed on the surface made of an organic material, there was formed a layer in which the organic material intermingled with the material (component) of the gas barrier layer, which caused the phenomenon at issue.

Suppose a gas barrier layer is being formed on the surface of an organic material by plasma-enhanced CVD; at the time when plasma generation started, the plasma incident on the substrate, since it has high enough energy, will get into the bulk of the substrate (organic material) to form a mixed layer in which the organic material intermingles with the material that is to form the gas barrier layer. The amount of the organic material in the mixed layer decreases with the progress of the formation of the gas barrier layer, and a pure gas barrier layer portion with no organic material is eventually formed.

Thus, an attempt to form a gas barrier layer on the surface made of an organic material results in the formation of a mixed layer at the interface between the substrate and the pure gas barrier layer.

It should be noted here that the mixed layer does not have as effective gas barrier quality as the pure gas barrier layer. Hence, if a thick enough mixed layer is formed in such a case that the gas barrier layer is a silicon compound or aluminum compound film that is formed by a vapor-phase deposition process and which requires a certain thickness in order to exhibit gas barrier quality (i.e., a gas barrier layer that depends on its thickness for exhibiting gas barrier quality), the thickness of a substantial gas barrier layer that can be formed is too small to ensure the intended gas barrier quality.

If a sufficiently thick gas barrier layer is formed in order to compensate for the loss in gas barrier quality due to the formation of the mixed layer, it is possible to secure the intended gas barrier quality. However, the gas barrier layer formed by this method is so thick that the production rate of gas barrier films with a coating of the gas barrier layer deteriorates in points of material cost and production time of the gas barrier layer.

The present inventors conducted intensive studies with a view to solving those problems. As a result, they found that the smaller the plasma excitation power that was applied in plasma-enhanced CVD (the power input to perform plasma-enhanced CVD), the thinner the mixed layer (the more effectively the formation of the mixed layer could be suppressed).

On the other hand, the present inventors found, a higher plasma excitation power was favorable for the purpose of forming a gas barrier layer that was dense enough to have high gas barrier quality.

The method of the present invention for forming gas barrier layers has been accomplished on the basis of that finding; to form the gas barrier layer 30 on the substrate 20 whose surface is made of an organic material, the first power is first applied to form the first layer 31 in a specified thickness, then the first power is changed to the second power higher than the first power and the second power is applied to form the second layer 32 until the total thickness of the first layer 31 and the second layer 32 reaches an intended thickness.

To be more specific, the first power which is so low that it is difficult to form the mixed layer with it is first applied to form the first layer 31 on the surface of the substrate; thereafter, the first power is switched to the higher second power which is intense enough to assure high gas barrier quality, thereby forming the second layer 32 which combines with the first layer 31 to form the gas barrier layer 30 of the desired thickness; as the result, the generation of the mixed layer is suppressed (it is thin enough) and, what is more, the gas barrier layer 30 formed is adequately dense.

Thus, according to the present invention, one can form the second layer 32 the greater part of which is substantially dense to have high gas barrier quality and, hence, the gas barrier layer 30 having the intended gas barrier quality can be formed consistently. In addition, the suppression of the mixed layer combines synergistically with the improvement in film density to enable reduction in the thickness of the gas barrier layer 30, thus leading to an improvement in the production rate of gas barrier films due, for example, to reduced the materials cost, better utilization of materials, and shorter production time.

In the present invention, the first power is not particularly limited and may be determined as appropriate for such factors as the type (composition) of the gas barrier layer 30 to be formed, the types of reaction gases to be used, the deposition rate, the thickness of the gas barrier layer 30, and the gas barrier quality required. Preferably, the first power is adjusted to be 5 W or smaller, in particular, between 0.3 and 2 W, per square centimeter of the substrate's surface area.

By adjusting the first power to lie in the ranges set forth above, favorable results can be obtained, such as: the generation of the mixed layer is suppressed more effectively to ensure that it is thin enough; the thickness of the mixed layer is reduced while ensuring that the first layer 31 formed with the first power exhibits comparatively high gas barrier quality; light absorption and haze (light scattering) in the visible region can be reduced.

The lower limit of the thickness of the first layer 31 (a mixed layer) to be formed with the first power is not particularly limited but is preferably set as appropriate for such factors as the thickness of the desired gas barrier layer 30.

It should be noted here that according to the study of the present inventors, formation of the first layer 31 with the first power preferably continues until its thickness reaches at least 3 nm. In particular, it is more preferred to continue the formation of the first layer 31 until its thickness reaches at least 5 nm.

By applying the first power until the first layer 31 is formed to a thickness of at least 3 nm, in particular, at least 5 nm, the formation of the mixed layer can be brought to an end more positively so that the generation of the mixed layer during film formation with the second power, which is a favorable condition for the formation of the mixed layer with high enough electric power, can be prevented more positively.

Note that the thickness of the first layer 31 can be controlled by every known method of thickness control that is employed in vapor-phase deposition processes, including use of the deposition rate as determined preliminarily by experimentation or simulation and measurement of the actually formed layer with a laser displacement sensor or the like.

Similarly, the upper limit of the thickness of the first layer 31 is not particularly limited, either.

However, as already noted earlier, the second layer 32 which is formed with the second power is denser and, hence, features better gas barrier quality than the first layer 31 formed with the first power. Thus, in the present invention, the thicker the second layer 32 that is formed with the second power, the more advantageous the gas barrier layer 30 of the desired thickness is in terms of gas barrier quality, Considering all these points together, the thickness of the first layer 31 is preferably adjusted to 30 nm or less, in particular, 15 nm or less.

In the present invention, the second power is not particularly limited, either, and may be determined as appropriate for such factors as the type of the second layer 32 to be formed, the types of reaction gases to be used, the deposition rate, the thickness of the gas barrier layer 30, and the gas barrier quality required.

It should be noted here that according to the study of the present inventors, whatever the intensities of the first and second power, the second power is preferably at least 1.5 times the first power. It is particularly preferred that the second power is at least twice the first power. If the first and second powers satisfy these conditions, formation of the mixed layer can be suppressed more effectively to form the gas barrier layer 30 that is denser to feature better gas barrier quality, that can reduce the light absorption and haze in the visible region, and which yet adheres strongly to the substrate 20.

It should also be noted that for various reasons such as the ability to form the second layer 32 that is denser and higher in gas barrier quality as well as the ability to prevent undue temperature rise during the process, the second power is preferably adjusted to between 0.5 and 10 W, in particular, between 1 and 5 W, per square centimeter of the substrate's surface area.

The thickness of the second layer 32 to be formed with the second power may be set as appropriate for the thickness of the first layer 31 and the thickness of the intended gas barrier layer 30.

Note that the thickness of the gas barrier layer 30 (the total thickness of the first layer 31 and the second layer 32) is not particularly limited and may be set as appropriate for such factors as the type of the gas barrier layer 30, the required gas barrier quality and the specific use of the gas barrier film as the final product with the coating of the gas barrier layer.

Take, for example, the case of forming a silicon nitride film or a silicon oxide film as the gas barrier layer 30; the preferred thickness of the gas barrier layer 30 is between about 20 and 1000 nm.

In the present invention, the material of the gas barrier layer 30 to be formed is not particularly limited and all known types of gas barrier layer can be employed as long as they can be formed by plasma-enhanced CVD on the surface made of an organic material.

For especial reasons such as the ability by which the effect of the present invention can be exhibited advantageously, particularly preferred gas barrier layers are those which are made of silicon compounds such as silicon oxide, silicon nitride, silicon oxynitride and silicon oxynitrocarbide. Among these silicon compounds, silicon nitride is an advantageous example.

During plasma-enhanced CVD of the gas barrier layer 30, particularly one that is made of a silicon compound, film quality such as gas barrier quality may deteriorate due, for example, to side reactions (mainly oxidation) that occur during the process of film formation.

These side reactions are more likely to occur with lower plasma excitation power. In addition, nitrides are most adversely affected by the side reactions which are mainly oxidation.

As already mentioned, the method of the present invention starts with forming the first layer 31 with the first power and then switches the first power to the higher second power. Hence, according to the present invention, the side reactions can be suppressed more easily during film formation with the second power than with the first power. In addition, the film formed with the second power is usually thicker than what is formed with the first power.

Hence, by utilizing the present invention to form gas barrier layers made of silicon nitride, not only the aforementioned features of the present invention can be obtained but, at the same time, the possible deterioration in film quality due to the side reactions can also be suppressed considerably. As a result, using a silicon nitride film, gas barrier layers having the intended gas barrier quality can be formed consistently. This is a preferred embodiment since by utilizing the present invention to form a silicon nitride film as the gas barrier layer, the effect of the present invention can be exhibited in a more pronounced way.

The reaction gases used to form the gas barrier layer 30 are not particularly limited, either, and all known reaction gases may be used, depending upon the gas barrier layer to be formed. If a silicon nitride film is to be formed as the gas barrier layer 30, silane gas and ammonia gas and/or nitrogen gas may be used as reaction gases; if a silicon oxide film is to be formed, both silane gas and oxygen gas may be used as reaction gases. Note that the reaction gases may, if necessary, be used in combination with various other gases such as inert gases including helium gas, neon gas, argon gas, krypton gas, xenon gas and radon gas.

In the method of the present invention, the aforementioned first power is preferably adjusted to 2 W or less, more preferably to 1 W or less, with respect to the total gas flow in sccm. If these conditions are met by the relation between the first power and the total gas flow, preferred results are obtained, including, for example, the ability to suppress the generation of the mixed layer more advantageously to reduce its thickness, the ability of the first layer 31 to exhibit comparatively high gas barrier quality, the ability to suppress the side reactions (mainly oxidation) that might occur during the formation of the first layer 31, and the ability to reduce light absorption and haze in the visible region.

Except for switching the plasma excitation power from the first to the second power, the conditions for forming (depositing) the gas barrier layer 30, such as the flow rates of the reaction gases, the relative flow rates of the reaction gases, the frequency of the plasma excitation power, the temperature for forming the gas barrier layer (the substrate's temperature) and the deposition rate, may be the same as those for the formation of ordinary gas barrier layers.

Thus, the conditions for forming the gas barrier layer 30 may be set as appropriate for the types of the gas barrier layer to be formed and the reaction gases used, the required deposition rate, the desired thickness of gas barrier layer, and the indented gas barrier quality.

Also note that the conditions for forming the first layer 31 with the first power and those for forming the second layer 32 with the second power are the same, except for the plasma excitation power. In short, the gas barrier layer 30 is formed under basically fixed conditions, except that the value of the plasma excitation power is changed in the process. In one example, the same reaction gases are introduced throughout the process of forming the gas barrier layer 30, provided that the switch is made from the first to the second power in the process. No other conditions for film deposition are changed but simply the switch is made from the first to the second power and yet the suppressive effect on the formation of the mixed layer is adequately obtained.

However, in the present invention, the formation of the first layer 31 with the first power and that of the second layer 32 with the second power may be performed with conditions other than the plasma excitation power, such as the flow rates of reaction gases, being also changed.

While the method of the present invention for forming the gas barrier layer 30 and the gas barrier layer 30 that is formed by the method have been described above in detail, the present invention is by no means limited to the foregoing embodiment and it should be understood that various improvements and modifications can of course be made without departing from the gist of the present invention.

On the following pages, specific examples of the present invention are given in order to describe it in greater detail.

### EXAMPLE 1

Using a common CVD apparatus of a type that would perform film deposition by the CCP-CVD process, a gas barrier film 10 comprising a substrate 20 with a silicon nitride layer formed thereon as a gas barrier layer 30 was prepared, as shown in FIG. 1.

The substrate 20 was a polyester film with a thickness of 188 μm (LUMINICE, a polyethylene terephthalate film manufactured by TORAY ADVANCED FILM CO., LTD.) The substrate 20 had a surface area of 300 cm².

The substrate 20 was set up in a predetermined position within a vacuum chamber (process chamber) provided in the CVD apparatus, and the vacuum chamber was then closed.

Subsequently, the interior of the vacuum chamber was evacuated and at the point in time when the internal pressure reached 0.01 Pa, silane gas, ammonia gas and nitrogen gas were introduced into the vacuum chamber as reaction gases. The silane gas was flowed at a rate of 50 sccm, the ammonia gas at 100 sccm, and the nitrogen gas at 150 sccm.

Evacuation of the interior of the vacuum chamber was adjusted such that its internal pressure becomes 100 Pa.

Subsequently, RF power having a frequency of 13.56 MHz was applied to electrodes provided in the CVD apparatus as plasma excitation power to start the formation of a gas barrier layer 30 on a surface of the substrate 20.

In the process of the formation of a gas barrier layer 30, the plasma excitation power being supplied to the electrodes was switched from the first power to the second power so that a gas barrier layer 30 (silicon nitride layer) was formed in a thickness of 50 nm on the substrate. Note that the intensity of the first power was 300 W and that of the second power was 600 W. As already mentioned, the substrate had a surface area of 300 cm² so the intensity of the first power was 1 W per square centimeter of the surface area of the substrate.

To ensure that the thickness of the first layer 31 formed with the first power would be 0 nm (i.e., only the second power was used to form the gas barrier layer 30), 3 nm, 5 nm, 10 nm or 50 nm (i.e. only the first power was used to form the gas barrier layer 30), the timing for the switch from the first power to the second power was accordingly changed, thereby forming five samples of gas barrier layer (hence, gas barrier film using the PET substrate).

Note that the thickness of the first layer 31 (i.e., the timing for the switch from the first power to the second power) and the thickness of the gas barrier layer 30 (=50 nm) were controlled by deposition rates that were preliminarily determined through experimentation.

The thus prepared five samples of gas barrier film were measured for water-vapor transmission rate (WVTR [g/(m²·day)]) by the MOCON method. Note that those samples which exceeded the limit for measurement of WVTR by the MOCON method were measured for WVTR by the calcium corrosion method (see JP 2005-283561 A).

The results are shown in Table 1 below.

TABLE 1

| Film thickness with | Film thickness with | WVTR |
|---|---|---|
| first power [nm] | second power [nm] | [g/m² · day] |
| 0 | 50 | 0.022 |
| 3 | 47 | 0.0073 |
| 5 | 45 | 0.0012 |
| 10 | 40 | 0.0016 |
| 50 | 0 | 0.087 |

As shown in Table 1, the samples of gas barrier film having the gas barrier layer 30 that was formed by the method of the present invention characterized by switching the plasma excitation power from the first to the second power in the process of the formation of the gas barrier layer had outstandingly superior gas barrier quality compared to gas barrier films having the conventional gas barrier layer all part of which was formed with either the first or the second power. In particular, the samples of gas barrier film in which the first layer 31 was formed to thicknesses of 5 nm and 10 nm by means of the first power had outstandingly high gas barrier quality as demonstrated by WVTR values of less than 0.002 [g/(m²·day)].

### EXAMPLE 2

Samples of gas barrier film 10 with a gas barrier layer 30 formed on the substrate 20 were prepared as in Example 1, except that the plasma excitation power to be supplied to the electrodes and, accordingly, the flow rates of reaction gases were changed.

Note that in the formation of each sample of gas barrier film 10, the thicknesses of the first layer 31 and the second layer 32 were fixed at 5 nm and 45 nm, respectively.

The second power was adjusted to be twice the first power. For example, when the intensity of the first power was 300 W, the second power was adjusted to have an intensity of 600 W.

As for the reaction gases, the ratio of their flow rates was fixed and they were flowed such that their total flow rate would be 1 sccm per watt of the first power. To be more specific, since the substrate had a surface area of 300 cm², the first power to be supplied was 1500 W when its intensity was 5 W per square centimeter of the substrate's surface area. As a result, the total flow rate of the reaction gases was 1500 sccm.

Under those conditions, the intensity of the first power was changed to 300 W (1 W per square centimeter of the substrate's surface area), 600 W (2 W/cm²), 1000 W (3.33 W/cm²), 1500 (5 W/cm²), or 2400 W (8 W/cm²), thereby forming gas barrier layers.

The five samples of gas barrier film thus prepared were measured for WVTR [g/(m²·day)] as in Example 1; in addition, after the formation of the gas barrier layer, the substrate was visually checked for any deformation.

The following criteria were adopted to evaluate the deformation of the substrate:
⊚, no change in appearance;
◯, a change in appearance was recognized but the sample was applicable as a gas barrier film; Δ, no sign was recognized of re-solidification after fusion, but the sample deformed so much that it was no longer applicable as a gas barrier film; and
×, a sign of re-solidification after fusion was recognized.

The data for the intensity of the first power with respect to the surface area of the substrate [W/cm²], as well as WVTR and the deformation of the substrate are shown in Table 2 below.

TABLE 2

| First power | WVTR | Deformation |
|---|---|---|
| [W/cm²] | [g/m² · day] | of substrate |
| 1 | 0.0012 | ⊚ |
| 2 | 0.0009 | ⊚ |
| 3.33 | 0.0045 | ◯ |
| 5 | 0.0096 | ◯ |
| 8 | 0.038 | Δ |

As Table 2 shows, by adjusting the intensity of the first power per surface area of the substrate to 5 W/cm² and less, gas barrier films could be obtained that had not only satisfactory gas barrier quality but also adequate resistance against deformation of the substrate. An increased intensity of the first power resulted in a thicker mixed layer but the subsequent film deposition with the second power provided a sufficient compensation in gas barrier quality.

The gas barrier film prepared by supplying the first power greater than 5 W per square centimeter of the substrate's surface area showed an unduly high water vapor transmission rate. The present inventors speculate that the following would be the reason for this phenomenon: given that condition for film deposition, the intensities of the first and the second power were so great that the temperature rose excessively enough to deform the substrate, whereupon fine cracks were induced in the silicon nitride film (gas barrier layer) or the material of the substrate got into the same silicon nitride film (causing its contamination). Thus, it may be said that the phenomenon at issue took place because the substrate used in the experiment did not have high enough heat resistance to withstand the actual condition of film deposition employed; if a more heat-resistant substrate were used, the effect of the gas barrier layer of the present invention could be obtained with the first power greater than 5 W/cm².

Hence, whichever the case, the result of Example 1 demonstrates that according to the method of the present invention in which the plasma excitation power is switched from the first power to the higher, second power in the process of film deposition, gas barrier films can be produced that have better gas barrier quality than what is obtained by the conventional method in which the entire process of film deposition is carried out with either the first or the second power.

What is claimed is:

1. A method of forming a gas barrier layer comprising:
forming a first layer over a substrate by plasma-enhanced CVD with a first plasma excitation power, at least a part of a surface of the substrate being made of an organic material; and
forming a second layer on the first layer by plasma-enhanced CVD with a second plasma excitation power which is higher than the first plasma excitation power.

2. The method according to claim 1, wherein the second plasma excitation power is 1.5 times or more of the first plasma excitation power.

3. The method according to claim 1, wherein the first layer is formed with the first plasma excitation power until its thickness is 3 nm or more.

4. The method according to claim 1, wherein the first layer is formed within a process chamber filled with reaction gases, and wherein the first plasma excitation power has an intensity of 2 W or less per sccm of the total flow of the reaction gases introduced into the vacuum chamber.

5. The method according to claim 1, wherein the first plasma excitation power is 5 W or less per square centimeter of the surface of the substrate.

6. A gas barrier layer formed by the method of claim 1.

7. A gas barrier film comprising:
a substrate at least a part of a surface of which is made of an organic material; and
the gas barrier layer of claim 6 which is formed over the substrate.
